(19) United States
(12) Patent Application Publication
(10) Pub. No.: US 2023/0220862 A1
(43) Pub. Date: Jul. 13, 2023

(54) NOVEL CONNECTION MECHANISM AND BED USING SAME

(71) Applicant: MlilyUSA, Inc, Knoxville, TN (US)

(72) Inventors: Zhiyong Xie, Knoxville, TN (US); Jian Sun, Knoxville, TN (US)

(21) Appl. No.: 18/095,113

(22) Filed: Jan. 10, 2023

Related U.S. Application Data
(60) Provisional application No. 63/298,730, filed on Jan. 12, 2022.

(51) Int. Cl. F16B 12/56

(52) U.S. Cl. CPC F16B 12/56

(57) ABSTRACT

Aspects of the invention include a connection mechanism and a bed therewith. The connection mechanism comprises a first bracket having a body plate, and two tabs and vertically extended/bent from two opposite side edges of the body plate to define a first angle relative to the body plate; and a second bracket having a body plate, and two tabs and vertically extended/bent from two opposite side edges of the body plate to define a second angle relative to the body plate. The first angle of the first bracket and the second angle of the second bracket are supplementary to each other such that one of the first bracket and the second bracket is complementarily and tightly receivable in another one of the first bracket and the second bracket.

### CROSS-REFERENCE TO RELATED PATENT APPLICATION

This application claims priority to and the benefit of U.S. Provisional Pat. Application Serial No. 63/298,730, filed Jan. 12, 2022, which is incorporated herein in its entirety by reference.

### FIELD OF THE INVENTION

The invention generally relates to a bed, and more particularly to novel connection mechanisms and beds using the same.

### BACKGROUND OF THE INVENTION

Sleep is critical for people in every aspect of their lives. Beds are necessary furniture for people to sleep on. Conventional beds usually require professionals to install, cannot be easily disassembled, thereby requiring more space to store and/or transport.

Thus, it is beneficial and desirable that a bed system can be easily assembled to improve assembly efficiency and increase the user’s assembly experience. It is also beneficial and desirable that the bed system can be easily disassembled so as to reduce the space for bed storage and transportation.

### SUMMARY OF THE INVENTION

In one aspect, the invention relates to a connection mechanism comprising a first bracket having a body plate, and two tabs and vertically extended/bent from two opposite side edges of the body plate to define a first angle α relative to the body plate; and a second bracket having a body plate, and two tabs and vertically extended/bent from two opposite side edges of the body plate to define a second angle β relative to the body plate. The first angle α of the first bracket and the second angle β of the second bracket are supplementary to each other such that one of the first bracket and the second bracket is complementarily and tightly receivable in another one of the first bracket and the second bracket.

In one embodiment, the first angle α is greater than about 90 degrees, the second angle β is less than about 90 degrees, and a sum of the first angle α and the second angle β is 180 degrees.

In one embodiment, the first bracket is operably received in the second bracket.

In one embodiment, the first bracket has a top end having a top width and an opposite, bottom end having a bottom width that is less than the top width.

In one embodiment, the second bracket has a top end having a top width and an opposite, bottom end having a bottom width that is less than the top width.

In one embodiment, the top width of the second bracket slightly greater than that of the first bracket, and the bottom width of the second bracket slightly greater than that of the first bracket, such that when in use, the first bracket is tightly received in the second bracket, and outer surfaces of the two tabs and of the first bracket abut against inner surfaces of the two tabs and of the second bracket.

In one embodiment, each of the body plates and of the first and second brackets and has a plurality of mounting holes defined thereon.

In one embodiment, the first bracket and the second bracket are made of a same rigid material or different rigid materials.

In one embodiment, each of the first bracket and the second bracket is made of steel, alloy, fiberglass, plastics, or wood.

In another aspect, the invention relates to a bed comprising a plurality of connection mechanisms. Each connection mechanism comprises a first bracket having a body plate, and two tabs and vertically extended/bent from two opposite side edges of the body plate to define a first angle α relative to the body plate; and a second bracket having a body plate, and two tabs and vertically extended/bent from two opposite side edges of the body plate to define a second angle β relative to the body plate, wherein the first angle α of the first bracket and the second angle β of the second bracket are supplementary to each other such that one of the first bracket and the second bracket is complementarily and tightly receivable in another one of the first bracket and the second bracket.

The bed further comprises a pair of side rails transversely spaced, longitudinally aligned and arranged parallel to each other; each side rail having a first end portion and an opposite, second end portion, wherein each end portion of the pair of side rails is attached with one bracket of one of the plurality of connection mechanisms; an upper rail and a lower rail longitudinally spaced and transversely extended, each of the upper rail and the lower rail having a first end portion and an opposite, second end portion, wherein each end portion of the upper rail and the lower rail is attached with one bracket of one of the plurality of connection mechanisms; and a plurality of support posts comprising at least four corner support posts, each corner support post having an upper portion having a first side and a second side perpendicularly extended from the first side, wherein each of the first and second sides and of each corner support post is attached with one bracket of one of the plurality of connection mechanisms.

As assembled, each corner support post is detachably connected to one of the side rails and one of the upper rail and the lower rail by receiving said brackets on the end portions of said one of the side rails and said one of the upper rail and the lower rail in said brackets on the first and second sides of said corner support post, respectively, so that that the upper rail and the lower rail and the pair of side rails are securely connected to each other in a rectangle form.

In one embodiment, the bed further comprises at least one ridge bar having each of two ends mounted with one bracket of one of the plurality of connection mechanisms, wherein a middle portion of each of the upper rail and the lower rail is attached with one bracket of one of the plurality of connection mechanisms, such that as assembled, said bracket on each end of the at least one ridge bar is received in said bracket of said one of the upper rail and the lower rail.

In one embodiment, the bed also comprises at least one headboard support bar detachably connected to the upper rail by one or more of the plurality of connection mechanisms; and at least one headboard detachably attached to the at least one headboard support bar by one or more of the plurality of connection mechanisms.

In one embodiment, the first angle α is greater than about 90 degrees, the second angle β is less than about 90 degrees, and a sum of the first angle α and the second angle β is 180 degrees.

In one embodiment, the first bracket is operably received in the second bracket.

In one embodiment, the first bracket has a top end having a top width and an opposite, bottom end having a bottom width that is less than the top width.

In one embodiment, the second bracket has a top end having a top width and an opposite, bottom end having a bottom width that is less than the top width.

In one embodiment, the top width of the second bracket slightly greater than that of the first bracket, and the bottom width of the second bracket slightly greater than that of the first bracket, such that when in use, the first bracket is tightly received in the second bracket, and outer surfaces of the two tabs and of the first bracket abut against inner surfaces of the two tabs and of the second bracket.

In one embodiment, each of the body plates and of the first and second brackets and has a plurality of mounting holes defined thereon.

In one embodiment, the first bracket and the second bracket are made of a same rigid material or different rigid materials.

In one embodiment, each of the first bracket and the second bracket is made of steel, alloy, fiberglass, plastics, or wood.

These and other aspects of the invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1A shows schematically a perspective view of a connection mechanism according to embodiments of the invention.

FIG. 1B shows schematically another perspective view of the connection mechanism shown in FIG. 1A.

FIG. 2A shows schematically a perspective view of a first bracket of the connection mechanism shown in FIG. 1A.

FIG. 2B shows schematically a front view of the first bracket of the connection mechanism shown in FIG. 1A.

FIG. 2C shows schematically a top view of the first bracket of the connection mechanism shown in FIG. 2A.

FIG. 3A shows schematically a perspective view of a second bracket of the connection mechanism shown in FIG. 1A.

FIG. 3B shows schematically a front view of the second bracket of the connection mechanism shown in FIG. 1A.

FIG. 3C shows schematically a top view of the second bracket of the connection mechanism shown in FIG. 1A.

FIG. 4 shows schematically a perspective view of a bed with connection mechanisms according to embodiments of the invention.

FIG. 5A shows schematically a partially perspective view of the bed with the connection mechanisms, showing connections of a corner support post, a lower rail and a side rail at a corner of the bed in portion A shown in FIG. 4.

FIG. 5B shows schematically a perspective view of a corner support post with connection mechanisms according to embodiments of the invention.

FIG. 5C shows schematically a perspective view of a lower rail with connection mechanisms according to embodiments of the invention.

FIG. 5D shows schematically a perspective view of a side rail with connection mechanisms according to embodiments of the invention.

FIG. 6 shows schematically a perspective view of a bed with connection mechanisms according to embodiments of the invention.

FIG. 7 shows schematically a partially perspective view of the bed with the connection mechanisms, showing connections of a support ridge bar and a lower rail, in portion B shown in FIG. 6.

FIG. 8 shows schematically a perspective view of a bed with connection mechanisms according to embodiments of the invention.

FIG. 9A shows schematically a partially perspective view of the bed with the connection mechanisms, showing connections of a lower rail and a headboard support bar, in portion C shown in FIG. 8.

FIG. 9B shows schematically a perspective view of a headboard support bar with connection mechanisms according to embodiments of the invention.

FIG. 10 shows schematically a perspective view of a bed with connection mechanisms according to embodiments of the invention.

FIG. 11A shows schematically a partially perspective view of the bed with the connection mechanisms, showing connections of a headboard and a headboard support bar, in portion D shown in FIG. 10.

FIG. 11B shows schematically a partially perspective view of the bed with the connection mechanisms, showing connections of two headboards and a headboard support bar, in portion E shown in FIG. 10.

FIG. 11C shows schematically a partially perspective view of a first headboards with connection mechanisms according to embodiments of the invention.

FIG. 11D shows schematically a partially perspective view of a second headboards with connection mechanisms according to embodiments of the invention.

FIG. 12 shows schematically a perspective view of a bed with connection mechanisms according to embodiments of the invention.

FIG. 13 shows schematically another perspective view of the bed with connection mechanisms shown in FIG. 12.

FIG. 14 shows schematically a front view of the bed with connection mechanisms shown in FIG. 12.

FIG. 15 shows schematically a side view of the bed with connection mechanisms shown in FIG. 12.

FIG. 16 shows schematically a top view of the bed with connection mechanisms shown in FIG. 12.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

Furthermore, relative terms, such as “lower” or “bottom” and “upper” or “top,” may be used herein to describe one element’s relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprise(s)” and/or “comprising,” or “include(s)” and/or “including” or “has (have)” and/or “having” or “contain(s)” and/or “containing” when used in this specification specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used in this specification, the term “platform” refers to a bed board.

As used in this specification, the phrase “at least one of A, B, and C” should be construed to mean a logical (A or B or C), using a non-exclusive logical OR. As used herein, the term “and/or” includes any and all combinations of one or more of the associated listed items.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

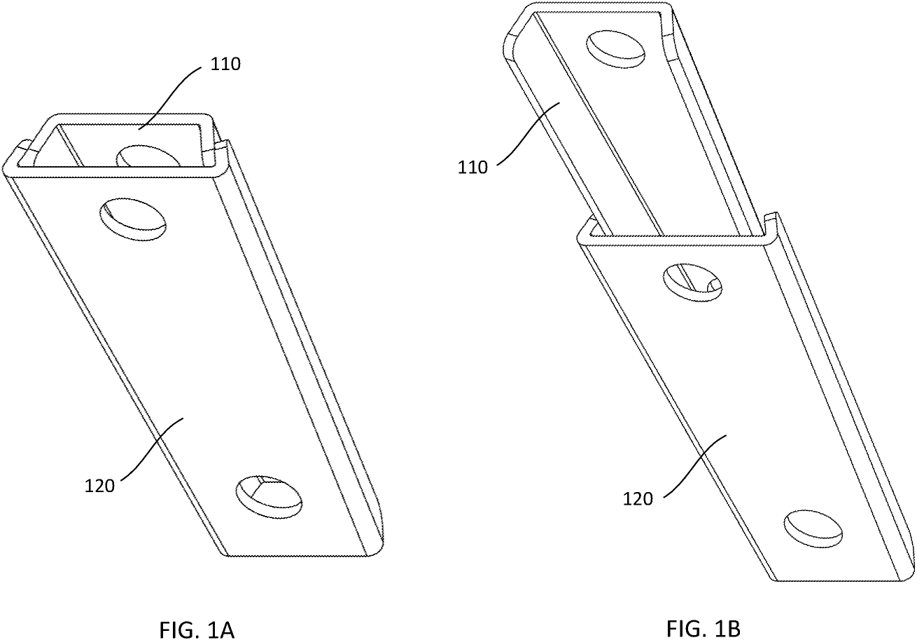

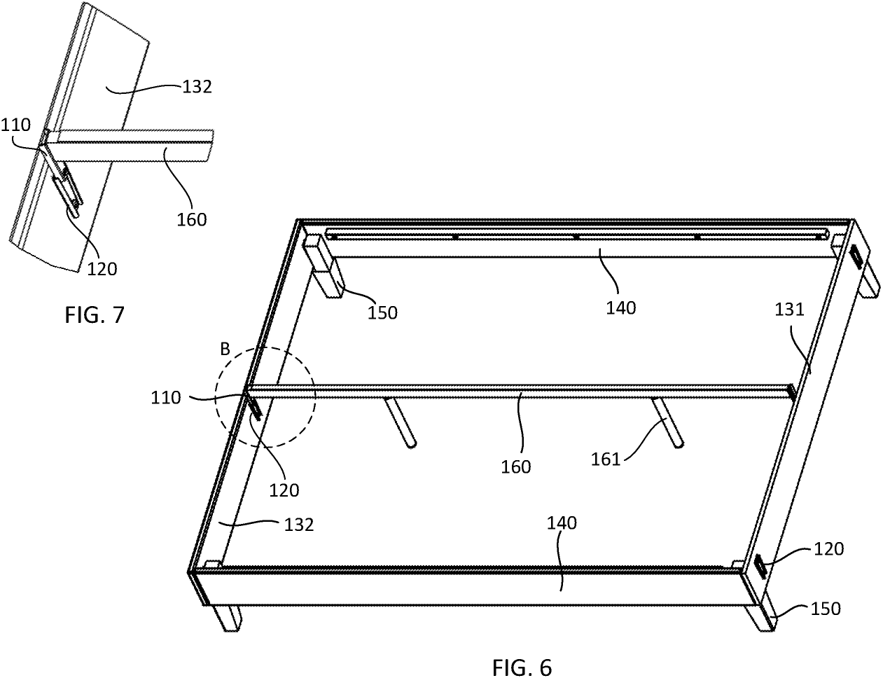

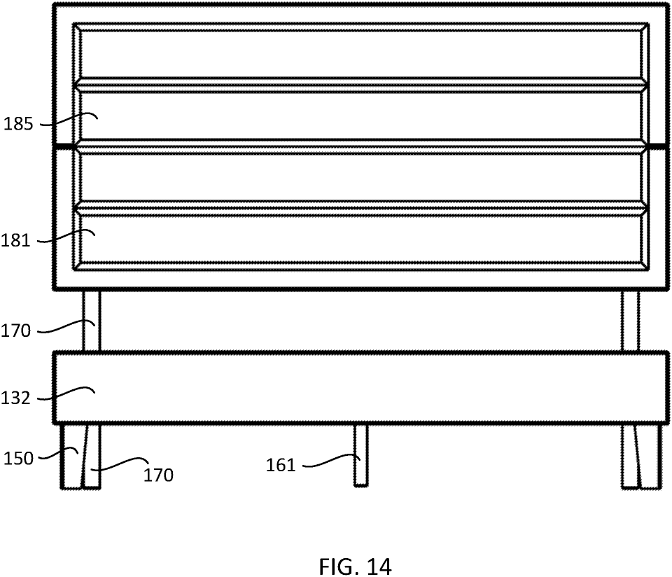

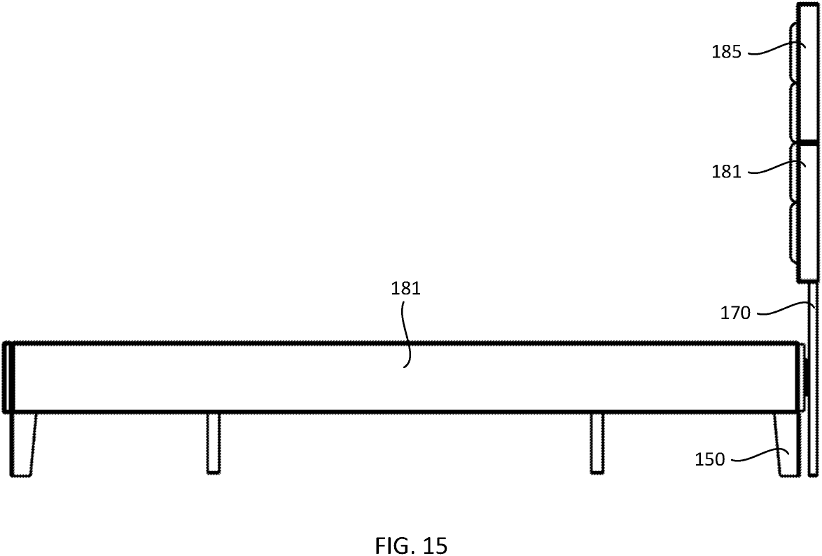

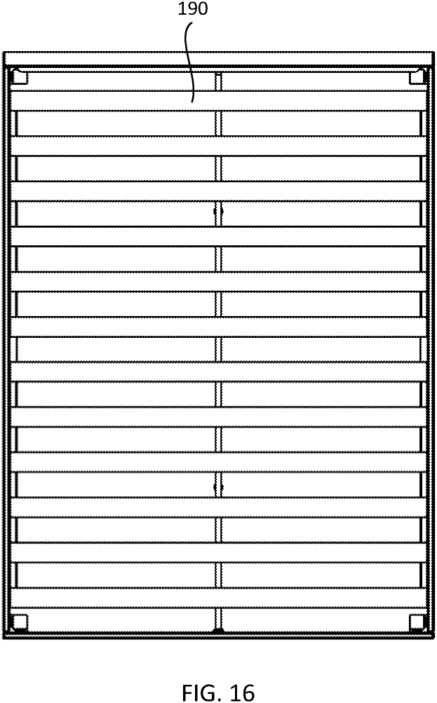

In accordance with the purposes of this invention, as embodied and broadly described herein, this invention, in one aspect, relates to a novel connection mechanism and a bed using the same. Exemplary embodiments of the invention will be described in conjunction with the accompanying drawings in FIGS. 1A-16. For purposes of clarity, the same reference numbers will be used in the drawings to identify similar elements.

Referring to FIGS. 1A-1B, 2A-2C and 3A-3C, the novel connection mechanism comprises a first bracket 110 and a second bracket 120 according to embodiments of the invention. The first bracket 110 and the second bracket 120 are designed to be complimentary to each other in general. The first bracket 110 is operably receivable in the second bracket 120, as shown in FIGS. 1A-1B, or vice versa.

Specifically, the first bracket 110 has a body plate 111, and two tabs 113 and 115 vertically extended/bent from two opposite side edges of the body plate 111 to define a first angle α relative to the body plate 111. The second bracket 120 has a body plate 121, and two tabs 123 and 125 vertically extended/bent from two opposite side edges of the body plate 120 to define a second angle β relative to the body plate 121. The first angle α of the first bracket 110 and the second angle β of the second bracket 120 are supplementary to each other such that one of the first bracket 110 and the second bracket 120 is complementarily and tightly receivable in another one of the first bracket 110 and the second bracket 120.

In one embodiment, the first angle α is greater than about 90 degrees, the second angle β is less than about 90 degrees, and a sum of the first angle α and the second angle β is about 180 degrees.

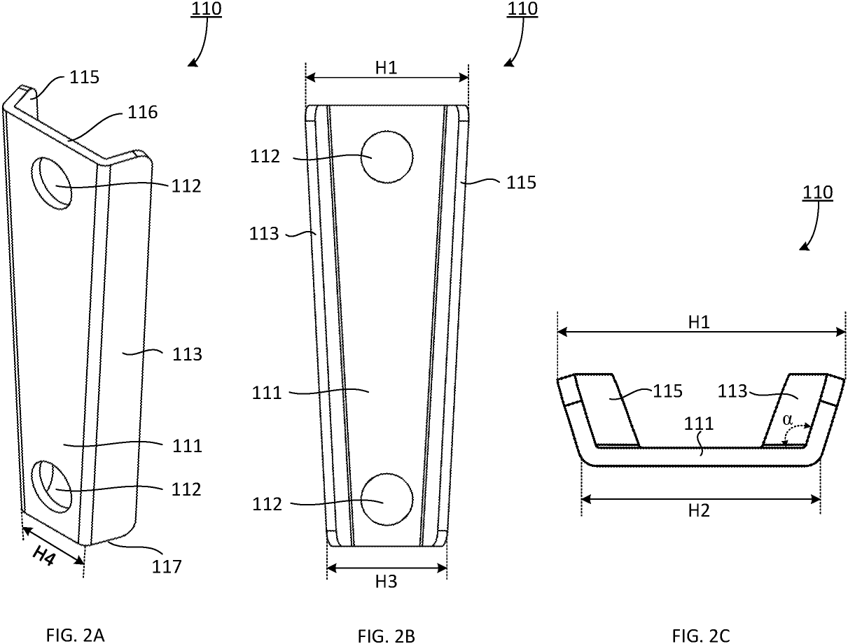

As shown in FIGS. 2A-2C, the first bracket 110 has a top end 116 and an opposite, bottom end 117 in a trapezoid structure. The body plate 111 has a top body width H2 and a bottom body width H4 defined at the top end 116 and the bottom end 117, respectively. The bottom body width H4 is less than the top body width H2. The outer surfaces of two tabs 113 and 115 define a top tab width H1 and a bottom tab width H3 at the top end 116 and the bottom end 117, respectively. The bottom tab width H3 is less than the top tap width H1.

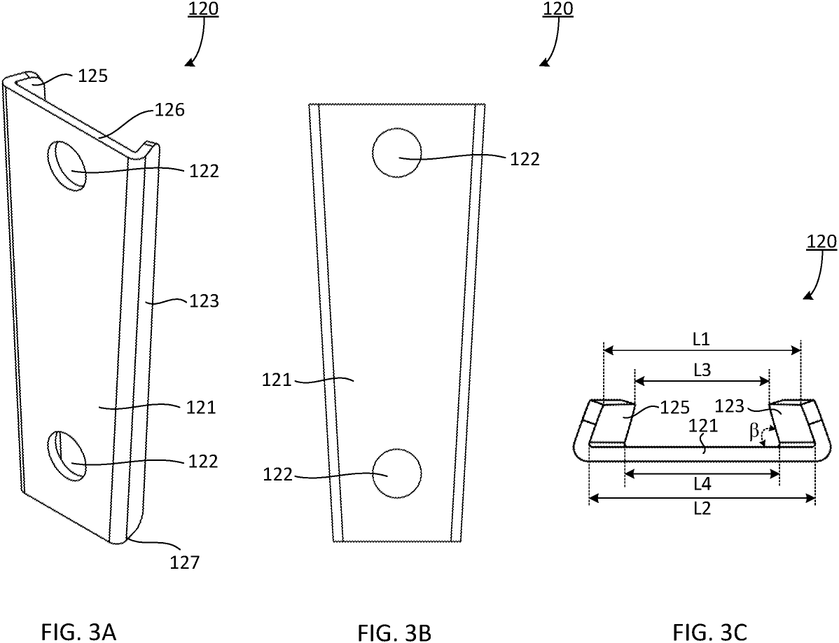

As shown in FIGS. 3A-3C, the second bracket 120 has a top end 126 and an opposite, bottom end 127 in a trapezoid structure. The body plate 121 has a top body width L2 and a bottom body width L4 defined at the top end 126 and the bottom end 127, respectively. The bottom body width L4 is less than the top body width L2. The inner surfaces of two tabs 123 and 125 define a top tab width L1 and a bottom tab width L3 at the top end 126 and the bottom end 127, respectively. The bottom tab width L3 is less than the top tab width L1.

In one embodiment, the top tab width L1 of the second bracket 120 slightly greater than the top tab width H1 of the first bracket 110, the bottom tap width L3 of the second bracket 120 slightly greater the bottom tap width H3 of the first bracket 110, the top body width L2 of the second bracket 120 slightly greater than the top tab width H2 of the first bracket 110, and the bottom tap width L4 of the second bracket 120 slightly greater the bottom tap width H4 of the first bracket 110, such that when assembled, the first bracket 110 is tightly received in the second bracket 120, and outer surfaces of the two tabs 113 and 115 of the first bracket 110 abut against inner surfaces of the two tabs 123 and 125 of the second bracket 120. As such, when the first bracket 110 is received in the second bracket 120, it is tightly attached into the second bracket 120 because of the trapezoid structures of the first and second brackets 110 and 120. Further, the first bracket 110 can be detached from the second bracket 120, by simply pulling out the first bracket 110 from the second bracket 120. It should be noted that the term “slightly greater” may refer to “0.1 mm greater”, “0.5 mm greater”, “1 mm greater” “1.5 mm greater”, “2 mm greater”, or any of other values.

In addition, each of the body plates 111 and 121 of the first and second brackets 110 and 120 has a plurality of mounting holes 112/122 through which the bracket is attached/mounted onto an object/component to be connected.

The first bracket 110 and the second bracket 120 can be made of a same rigid material or different rigid materials. Each of the first bracket 110 and the second bracket 120 can be made of steel, alloy, fiberglass, plastics, wood, or the like.

The structure of the novel connection mechanism makes assembly and/or disassembly of furniture such as a bed much easier and more efficient, thereby improving the user’s experience.

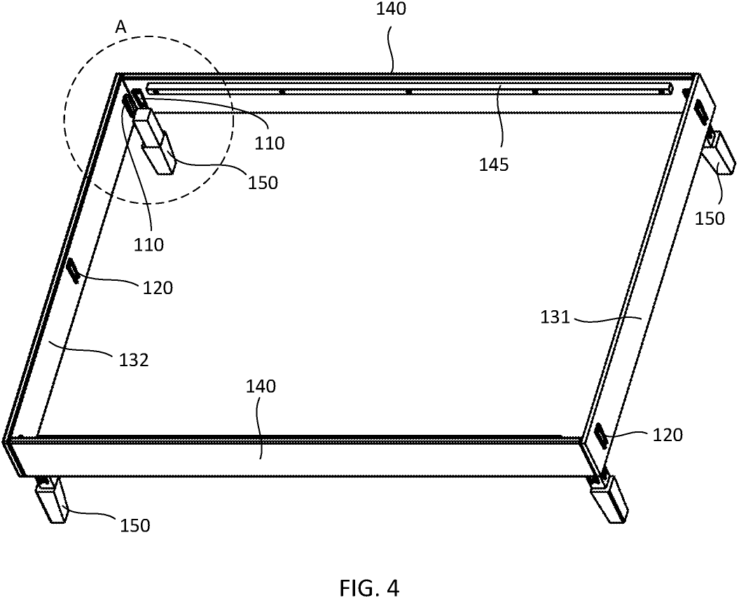

Referring to FIGS. 4-16, a bed with the connection mechanisms according to embodiments of the invention. The bed includes various components such as frame rails, deck boards 190, headboards 181 and 185, support posts 150, and so on. The bed also includes a plurality of connection mechanisms to connect these various components. Each connection mechanism is shown in FIGS. 1A-1B, 2A-2C and 3A-3C and described above.

The frame rails include a pair of side rails 140, an upper rail 131 and a lower rail 132.

The pair of side rails 140 is transversely spaced, longitudinally aligned and arranged parallel to each other. Each side rail 140 have a first end portion and an opposite, second end portion. Each end portion of the pair of side rails 140 is attached/mounted with a first bracket 110 (or a second bracket 120).

The upper rail 131 and the lower rail 132 are longitudinally spaced and transversely extended. Each of the upper rail 131 and the lower rail 132 have a first end portion and an opposite, second end portion. Each end portion of the upper rail 131 and the lower rail 132 is attached/mounted with a first bracket 110 (or a second bracket 120).

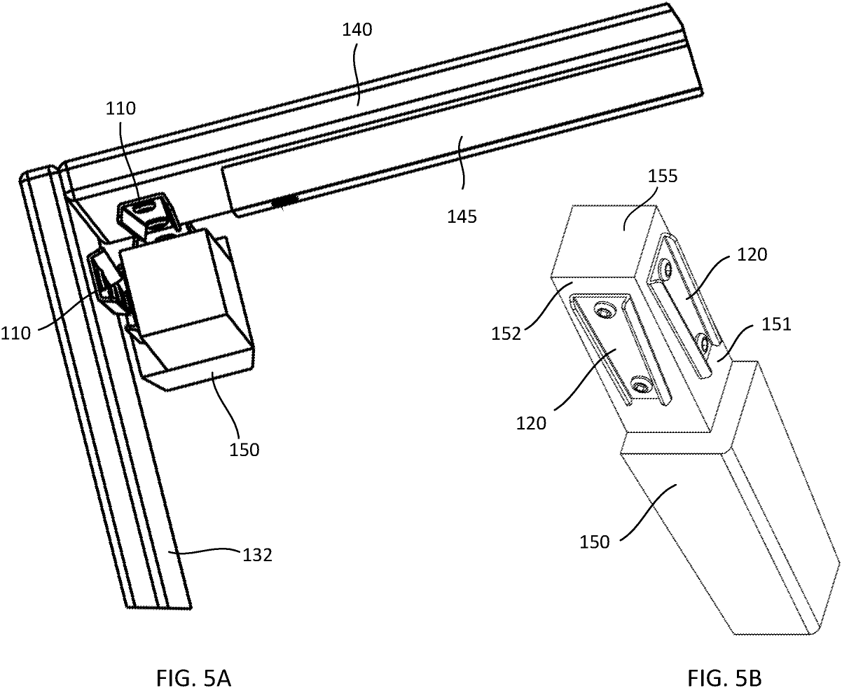

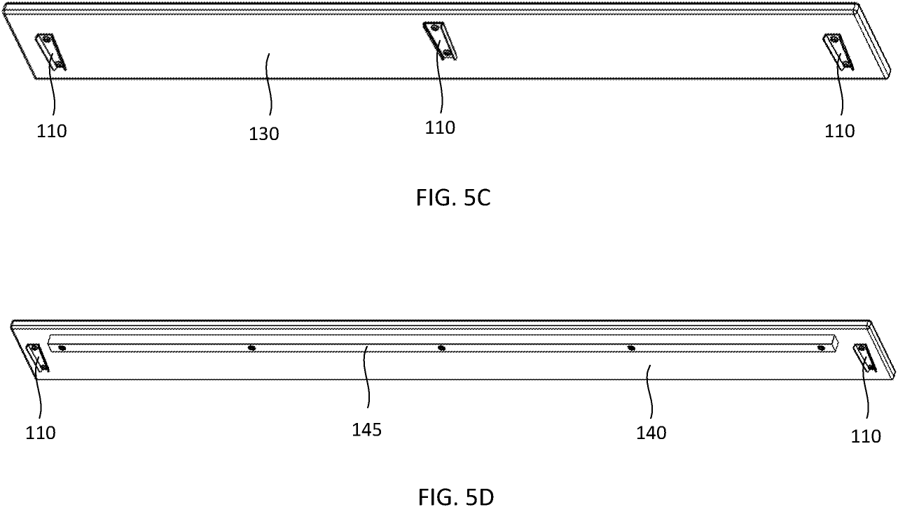

The support posts 150 include at least four corner support posts 150. As shown in FIG. 5B, each corner support post 150 includes an upper portion 155 having a first side 151 and a second side 152 perpendicularly extended from the first side 151. Each of the first and second sides 151 and 152 of the corner support post 150 is attached/mounted with a second bracket 120 (or a first bracket 110).

As assembled, each corner support post 150 is detachably connected to one of the side rails 140 and one of the upper and lower rails 131 and 132 by plugging the first brackets 110 attached/mounted on the end portions of said one of the side rails 140 and said one of the upper and lower rails 131 and 132 into the second brackets 120 attached/mounted on the first and second sides 151 and 152 of said corner support post 150, respectively, as shown in FIG. 5A. As such, the upper rail 131 and the lower rail 132 and the pair of side rails 140 are securely connected to each other in a rectangle form, as shown in FIG. 4. The bed can easily be disassembled by pulling out the first brackets 110 on the end portions of said one of the side rails 140 and said one of the upper and lower rails 131 and 132 from the second brackets 120 on the first and second sides 151 and 152 of said corner support post 150.

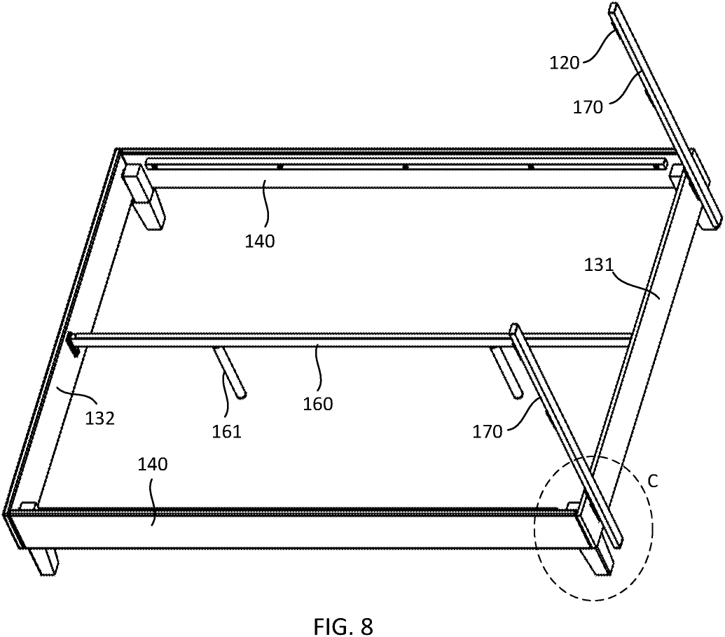

In addition, the bed further comprises at least one ridge bar 160 having each of two ends mounted with a first bracket 110 (or a second bracket 120). A middle portion of each of the upper and lower rails 131 and 132 is also attached/mounted with a second bracket 120 (or a first bracket 110). As assembled, the first brackets 110 on the two ends of the ridge bar 160 are securely received in the second brackets 120 one the middle portions of the upper rail 131 and the lower rail 132, respectively. The support posts may also include one or more posts 161 attached to the at least one ridge bar 160 for providing extra support for the bed, as shown in FIG. 8.

The bed also comprises one or more headboard support bars 170 detachably connected to the upper rail 131 by one or more of the plurality of connection mechanisms; and at least one headboard detachably attached to the at least one headboard support bar by one or more of the plurality of connection mechanisms.

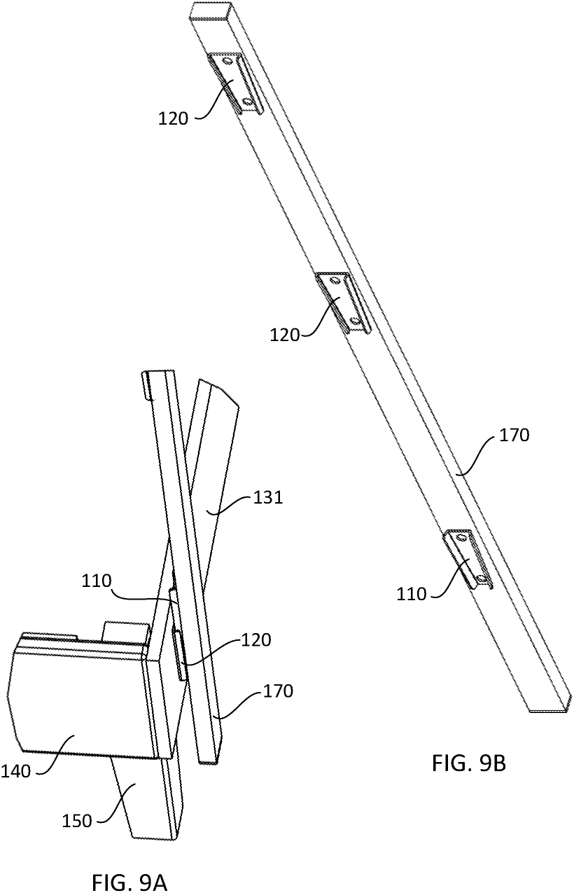

In one exemplary embodiment shown in FIGS. 8-10 and 11A-11D, two headboard support bars 170 are attached/mounted onto the outer side of the upper rail 131 through plugging the first brackets 110 (or the second brackets 120) mounted on the lower portion of the two headboard support bars 170 into the second brackets 120 (or the first brackets 110) mounted on the outer side of the upper rail 131, as shown in FIGS. 8 and 9A.

As shown in FIG. 9B, each of the top and middle portions of the headboard support bars 170 is also attached/mounted with the second bracket 120.

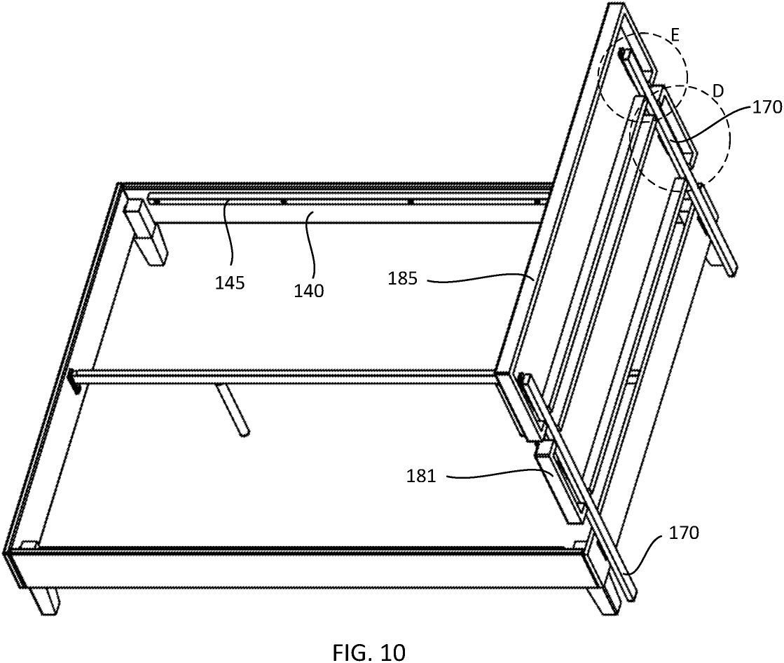

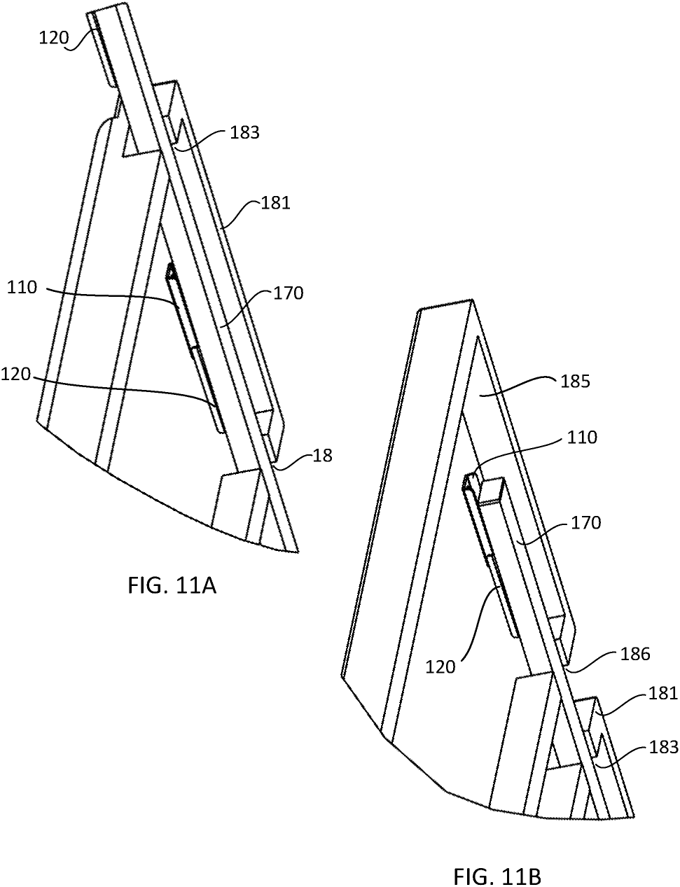

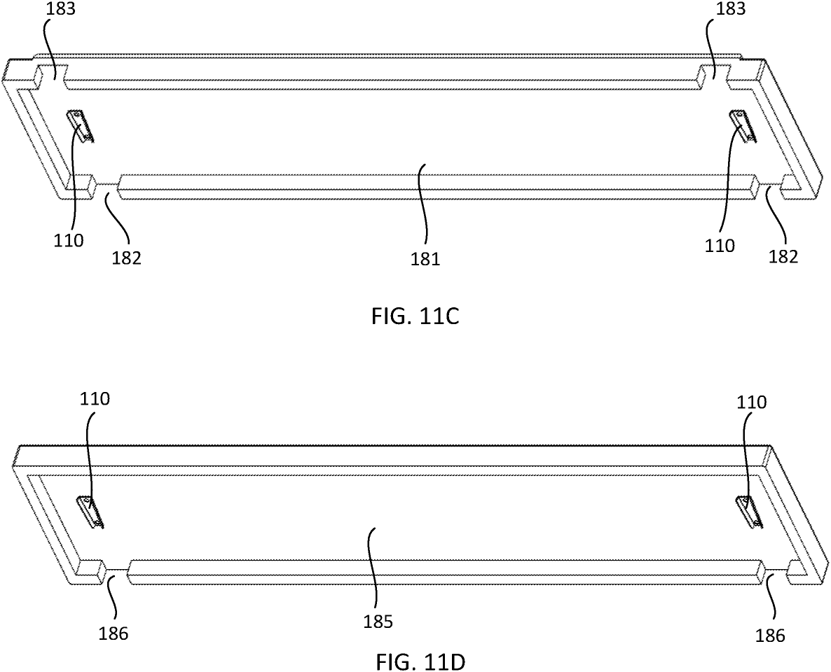

In the exemplary embodiment, the headboards has a first headboard 181 and a second headboard 185. Two first brackets 110 are mounted on each of the first headboard 181 and the second headboard 185 at the predetermined positions that are corresponding to the positions of the second brackets 120 mounted on the two headboard support bars 170, as shown in FIGS. 11C-11D. In addition, the first headboard 181 has grooves 182 and 183 formed on the bottom edge and the top edge, respectively, at positions corresponding to the two headboard support bars 170, while the second headboard 185 has grooves 186 formed on the bottom edge. These grooves 182, 183 and 186 are configured to accommodate the two headboard support bars 170 as assembled. In installation, the first brackets 110 on the first headboard 181 are plugging into the second brackets 120 on the middle portions of the two headboard support bars 170 that in turn, are accommodated in the grooves 182 and 183, and the first brackets 110 on the second headboard 185 are plugging into the second brackets 120 on the top portions of the two headboard support bars 170 that in turn, are accommodated in the grooves 186, so as to attach the first headboard 181 and the second headboard 185 to the two headboard support bars 170, thereby installing the headboards in the upper rails of the bed, as shown in FIGS. 10 and 11A-11D.

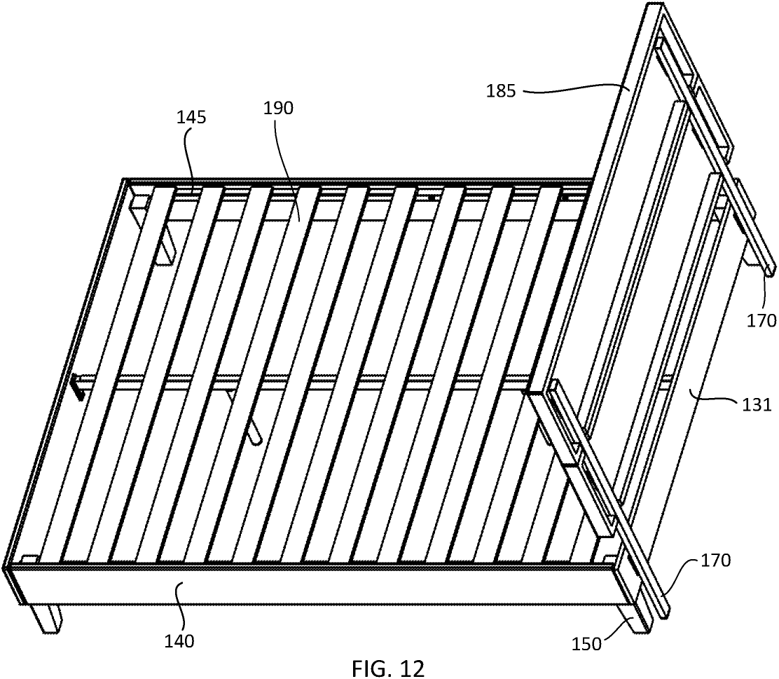

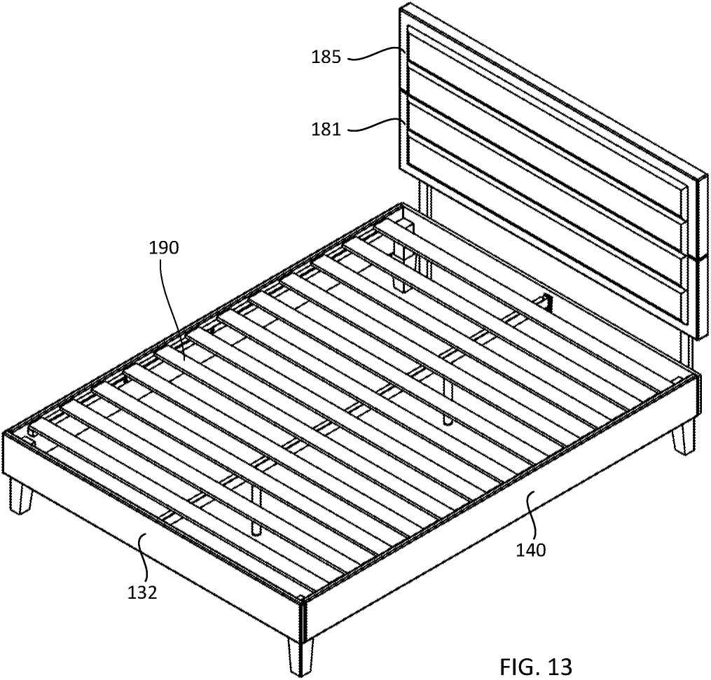

As shown in FIG. 12, the bed also includes a plurality of deck boards 190 longitudinally spaced and transversely disposed on the ridge bar 160 and the side support bar 145 mounted on the pair of side rails 140. The plurality of deck boards 190 is adapted for supporting the mattress. It should be appreciated that a single deck board may be utilized to practice the invention.

FIGS. 13-16 show different views of the bed according to embodiments of the invention.

Among other things, the structure of the invented novel connection mechanism makes assembly of the bed much easier and more efficient, thereby improving the user’s experience. In addition, the bed system can be easily disassembled by simply pulling out the first bracket 110 from the second brackets 120, thereby reducing the space for bed storage and transportation.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A connection mechanism, comprising:
a first bracket having a body plate, and two tabs and vertically extended/bent from two opposite side edges of the body plate to define a first angle relative to the body plate; and
a second bracket having a body plate, and two tabs and vertically extended/bent from two opposite side edges of the body plate to define a second angle relative to the body plate,
wherein the first angle of the first bracket and the second angle of the second bracket are supplementary to each other such that one of the first bracket and the second bracket is complementarily and tightly receivable in another one of the first bracket and the second bracket.

2. The connection mechanism of claim 1, wherein the first angle is greater than about 90 degrees, the second angle is less than about 90 degrees, and a sum of the first angle and the second angle is about 180 degrees.

3. The connection mechanism of claim 2, wherein the first bracket is operably received in the second bracket.

4. The connection mechanism of claim 2, wherein the first bracket has a top end having a top width and an opposite, bottom end having a bottom width that is less than the top width.

5. The connection mechanism of claim 4, wherein the second bracket has a top end having a top width and an opposite, bottom end having a bottom width that is less than the top width.

6. The connection mechanism of claim 5, wherein the top width of the second bracket slightly greater than that of the first bracket, and the bottom width of the second bracket slightly greater than that of the first bracket, such that when in use, the first bracket is tightly received in the second bracket, and outer surfaces of the two tabs and of the first bracket abut against inner surfaces of the two tabs and of the second bracket.

7. The connection mechanism of claim 1, wherein each of the body plates and of the first and second brackets and has a plurality of mounting holes defined thereon.

8. The connection mechanism of claim 1, wherein the first bracket and the second bracket are made of a same rigid material or different rigid materials.

9. The connection mechanism of claim 8, wherein each of the first bracket and the second bracket is made of steel, alloy, fiberglass, plastics, or wood.

10. A bed, comprising:
a plurality of connection mechanisms, each connection mechanism comprising:
a first bracket having a body plate, and two tabs and vertically extended/bent from two opposite side edges of the body plate to define a first angle relative to the body plate; and
a second bracket having a body plate, and two tabs and vertically extended/bent from two opposite side edges of the body plate to define a second angle relative to the body plate,
wherein the first angle of the first bracket and the second angle of the second bracket are supplementary to each other such that one of the first bracket and the second bracket is complementarily and tightly receivable in another one of the first bracket and the second bracket;
a pair of side rails transversely spaced, longitudinally aligned and arranged parallel to each other; each side rail having a first end portion and an opposite, second end portion, wherein each end portion of the pair of side rails is attached with one bracket of one of the plurality of connection mechanisms;
an upper rail and a lower rail longitudinally spaced and transversely extended, each of the upper rail and the lower rail having a first end portion and an opposite, second end portion, wherein each end portion of the upper rail and the lower rail is attached with one bracket of one of the plurality of connection mechanisms; and
a plurality of support posts comprising at least four corner support posts, each corner support post having an upper portion having a first side and a second side perpendicularly extended from the first side, wherein each of the first and second sides and of each corner support post is attached with one bracket of one of the plurality of connection mechanisms;
wherein as assembled, each corner support post is detachably connected to one of the side rails and one of the upper rail and the lower rail by receiving said brackets on the end portions of said one of the side rails and said one of the upper rail and the lower rail in said brackets on the first and second sides of said corner support post, respectively, so that that the upper rail and the lower rail and the pair of side rails are securely connected to each other in a rectangle form.

11. The bed of claim 10, further comprising at least one ridge bar having each of two ends mounted with one bracket of one of the plurality of connection mechanisms, wherein a middle portion of each of the upper rail and the lower rail is attached with one bracket of one of the plurality of connection mechanisms, such that as assembled, said bracket on each end of the at least one ridge bar is received in said bracket of said one of the upper rail and the lower rail.

12. The bed of claim 10, further at least one headboard support bar detachably connected to the upper rail by one or more of the plurality of connection mechanisms; and at least one headboard detachably attached to the at least one headboard support bar by one or more of the plurality of connection mechanisms.

13. The bed of claim 10, wherein the first angle is greater than about 90 degrees, the second angle is less than about 90 degrees, and a sum of the first angle and the second angle is about 180 degrees.

14. The bed of claim 13, wherein the first bracket is operably received in the second bracket.

15. The bed of claim 13, wherein the first bracket has a top end having a top width and an opposite, bottom end having a bottom width that is less than the top width.

16. The bed of claim 15, wherein the second bracket has a top end having a top width and an opposite, bottom end having a bottom width that is less than the top width.

17. The bed of claim 16, wherein the top width of the second bracket slightly greater than that of the first bracket, and the bottom width of the second bracket slightly greater than that of the first bracket, such that when in use, the first bracket is tightly received in the second bracket, and outer surfaces of the two tabs and of the first bracket abut against inner surfaces of the two tabs and of the second bracket.

18. The bed of claim 10, wherein each of the body plates and of the first and second brackets and has a plurality of mounting holes defined thereon.

19. The bed of claim 10, wherein the first bracket and the second bracket are made of a same rigid material or different rigid materials.

20. The bed of claim 19, wherein each of the first bracket and the second bracket is made of steel, alloy, fiberglass, plastics, or wood.
